(19) United States
(12) Patent Application Publication
(10) Pub. No.: US 2006/0202438 A1
(43) Pub. Date: Sep. 14, 2006

(54) Disposable Sanitary Shopping Cart Handle Cover for publicly used carts/rental strollers

(76) Inventors: Lesleigh Renee Helmy, Phoenix, AZ (US); Michale Craig, Mesa, AZ (US)

Correspondence Address: Lesleigh R. Helmy;Michale Craig, 1840 E. Donner Dr., Phoenix, AZ, 85042, US

(21) Appl. No.: 10/906,918

(22) Filed: Mar. 11, 2005

(51) Int. Cl. B62D 39/00

(52) U.S. Cl. 280/33.992

(57) ABSTRACT

The present invention, a Disposable Sanitary Shopping Cart Handle Cover for publicly used carts, carry baskets, and rental strollers, addresses the health risks consumers face by providing a barrier between the shoppers hands and the thousands of strains of germs/bacteria present on the surface of said handles. The preferred embodiment is a relatively thin rectangle of material, consisting of a double sided sheet composed of a front/top side, possibly made of a tissue type material with an attached back/bottom side, possibly made of an isolating plastic material which attaches directly to the handle in use, thereby providing germ-conscious individuals with an option to solve the problem of bacteria exposure, in a way not previously afforded to the public.

### 1. BACKGROUND OF INVENTION

The present invention addresses health risks consumers are exposed to every time there is a need to touch a cart, carry basket or rental stroller handle. As a disposable product, this invention will be easy to use, relatively inexpensive to produce, and cost effective for stores to offer their customers. This invention has an unequaled advantage in the marketplace, in that, THERE ARE CURRENTLY NO DISPOSABLE BARRIERS AVAILABLE TO THE PUBLIC FOR USE ON GROCERY/SHOPPING CARTS/CARRY BASKET/RENTAL STROLLER HANDLES. There is however, a growing awareness of the high risk of exposure to germs and bacteria, as several grocery stores through out the U.S. have begun to offer disposable wipes near the shopping carts for consumers to wipe the handles of the shopping carts clean.

The preferred embodiment is a handle cover comprising of a disposable double sided sheet composed of a front/top side made of a tissue type material with an attached back/bottom side made of an isolating plastic material with a pressure sensitive adhesive coating. The pressure sensitive adhesive coating is directly coated onto the isolating plastic material of the back side, and will have a release liner that is removed just prior to/during application of the disposable shopping cart cover. The invention can easily be removed from the shopping cart by grasping the edge of the back side at the point of adhesion to the front side and lifting to separate the two parts. This invention should be available to consumers in a freestanding roll similar to a number ticket roll system, or a plastic bag display system, although, not limited to such and should be displayed near the cart area in grocery/shopping stores/entertainment attraction areas which provide carts/baskets/strollers for their consumers use and convenience.

### 2. FIELD OF INVENTION

The present invention relates to shopping cart handle covers, more specifically to a disposable sanitary shopping cart handle cover, developed as a product with the consumers' best interest as the primary concern and has the sole purpose of providing consumers a barrier to the continuous exposure of germs/bacteria that are present upon the handles of public carts/strollers.

### 3. CURRENTLY MARKETED PRODUCTS

The majority of retail/entertainment outlets around the globe provide customers with shopping carts and/or rental strollers. While offering a great convenience, one problem which exists WORLDWIDE is the fact that uncountable numbers of people use such devices, each one depositing his/her own microorganisms upon the handle, and unfortunately, picking up those left behind by the previous user. Health department statistics as well as numerous media reports show that shopping cart handles have proven to be among the most germ-laden surfaces in any public area. This condition rings true in any town, in any industrialized country in the world. As such, the avoidance of touching infected handles may prevent the spread of colds, flu, and other diseases. The remaining lack of any such marketed device shows a definitive need for a disposable sanitary handle cover for use on grocery/shopping carts/carry basket/rental stroller handles.

The only product for shopping carts we have found to be currently produced and available for sale in the marketplace is an item for the use of infants/small children which covers the entire seat/handle area of a shopping cart as the child sits inside the cover. This product appears to be available in both a cloth as well as disposable material.

### 4. PRIOR ART˜ISSUED PATENTS

*U.S. Pat. No. 6,065,764 to Moseley discloses a sanitary teething cover for a shopping cart handle that is to be mouthed by a child or infant. This item is intended as a reusable product geared toward the best interest and entertainment of infants/children, and would require the consumer to wash the item after each use in order to claim the benefit of a continuous sanitary surface upon each subsequent use. *U.S. Pat. No. 5,215,319 to Farris discloses a single rolled sheet of semi-rigid plastic in the preferred embodiment of the invention. The rolled sheet is cut longitudinally along one side, with a notch, to facilitate the placement of the cover onto a shopping cart handle. An alternative embodiment of the handle cover of Farris '319, involves mounting a roll of plastic wrap, or other disposable material, with a cutting edge on the cart near the handle, so that each successive customer can pull a length of plastic wrap sufficient to cover the handle. In addition to posing a threat of possible injury from the cutting edge of the plastic wrap embodiment, there would appear to be opportunity for a great deal of wasted plastic wrap, should users be unable to effectively apply the product to the cart handle. Similarly, *U.S. Pat. No. 5,429,377 to Duer discloses a reusable sanitary protective cover for shopping cart use that is attached to a bag into which the protective cover may be inserted when the cover is folded. *U.S. Pat. No. 4,881,746 to Andreesen discloses a handle cover and toy holder that includes a cloth handle cover and attached toy holder where the toy holder is configured to secure the folded cloth handle cover when not in use. Duer's 377 & Andreesen's 746. Both appear to be composed of reusable materials. Designed with attachments of various sorts, both could be considered a nuisance to the consumer, as well as requiring washing after each use in order to provide a sanitary surface. *U.S. Pat. No. 2,803,849 to Peters discloses a continuous tubular paper cover that slips onto a specially designed shopping cart handle having one end that removably engages with the body of the cart. However, Peters' 849 is neither practical nor cost effective, as it would require replacement of all currently used shopping carts with new carts containing specially designed handles in order to be compatible. *U.S. Design Pat. No. 328,812 to Pritchett discloses a handle cover for a shopping cart that appears to be made of a strip of fabric having Velcro along a longitudinal edge to secure the fabric to the shopping cart handle. *U.S. Pat. No. 3,866,649, to Bringmann, discloses a handle cover with a zipper closure that can be used on a shopping cart. The Bringmann patent provides a plasticized polyvinyl chloride covering which includes a string of beads or a similar amusement device as a form of entertainment. *Pritchett's 812 and Bringmann's 649, again, reusable material requiring the consumer to wash the item in order to benefit from the claim of a sanitary surface. Furthermore, the intended beneficiary of said product, an infant or child faces a choking hazard by the presence of a string of beads accessible for their entertainment.

*U.S. Pat. No. 5,425,546, to Gerber claims a child handle cover and entertainment center which is intended to amuse and arouse the attention of the child carried in the shopping cart with a drawing surface where the child can either draw or color with a drawing instrument included with the handle cover and entertainment center. Said center can also contain advertisements or other commercial messages, or it can be in the form of a bingo card. This item may well be suitable to entertain children, however makes no claim, nor intended safeguard to the shopping consumer. A broader investigation shows *U.S. Pat. No. 2,888,761, to Miller, *U.S. Pat. No. 655,502, to Houllis, *U.S. Pat. No. 4,805,937 to Boucher, *U.S. Pat. No. 4,901,901 to Reitenour, as well as Economy, *U.S. Pat. No. 4,583,753, *PCT Patent No. 89/08040, *U.K. Patent No. 2 182 000 A, *U.K. Patent No. 2 176 332 A, *EPC Patent No. 0 297 452 A2 and *U.S. Pat. No. 5,004,252, to Kraper, describe shopping cart handle covers with various attachment devices and seat cushions geared at the entertainment of and use for babies and/or small children. Entertainment attachments pose a nuisance at best and a choking hazard a worst, and cushy seats offer no protection to the shopping consumer. Further research shows *U.S. Pat. No. 3,581,431 to Trenovan and *U.S. Pat. No. 4,708,691 to Moore disclose folding blanks and building forms which result in three-dimensional structures. Entertaining possibly, however, these items do not appear to offer a sanitary benefit to the consumer. *U.S. Pat. No. 3,629,960 to Froush discloses a removable desk top packet containing multiple learning and teaching devices to be placed on a desktop. This product, while educational, has the primary benefit being one of the entertainment of infants/small children.

### 5. PRIOR ART˜PATENT APPLICATIONS

*U.S. Pat. App. No. 20040189066, to Beaty, Sep. 30, 2004, claims a sanitary, portable and disposable cover for shopping cart handles and surrounding cart framework which uses a flexible planar sheet of a sanitary polymeric film that can be adhered and stretched taut across the space between the horizontal bar and the restraint railing, providing a protective covering over the horizontal bar and the restraint railing of the child's seat providing an activity center comprised of a transparent sheet wherein the back side of the sheet is reverse printed, producing viewable images on the front side of the sheet which consist of cartoon characters, foods, text, items found in a grocery store, advertisements, and television personalities, all of which allows the printed activity center to possibly be used as a tray to hold snacks or toys. This item designed to be potentially entertaining and educational to children, makes no claim of offering a sanitary benefit to the shopping consumer.

*U.S. Pat. No. 6,237,998, to Aprile, May 29, 2001, has a shopping cart seat cover body made from flexible sheet material. The seat cover has a front panel, a handle fold at the upper portion of the front panel, and an interior seat liner panel extending from the front panel at the handle fold. The interior seat liner panel has right and left child leg apertures in the front portion of the interior seat liner panel, a rear seat basket fold at the back of the interior panel, and a rear flap extending from the interior panel at the rear seat basket fold. The interior panel includes a plurality of aperture closure flaps extending across a left leg aperture and a plurality of aperture closure flaps extending across a right leg aperture of the interior panel. The interior panel further includes right and left shopping cart side rail cover flaps. The shopping cart seat cover includes left and right side shopping cart handle covers. A safety strap extends through the right and left safety flap apertures of the rear flap. The safety strap has a clasp located in between the interior panel and the rear flap. A child foot shield storage pouch extends downwardly from the front panel. The storage pouch has an interior volume that is sufficiently large to accommodate the shopping cart seat cover body. While this product would more than adequately cover the seating area for the child of the shopper, it does not address the risk faced by the shopping consumer, directing all claims of benefit toward the child. Furthermore, it would seem that the time required to install this product could be seen as a deterrent to potential users, and the amount of plastic needed to produce this product would contribute greatly to our planet's already overstuffed landfills.

*U.S. Pat. No. 6,817,066, to Williams, Nov. 16, 2004, claims a handle grip apparatus for preventing direct contact with unsanitary shopping cart handles that may be installed without touching the shopping cart handle directly using a section of foam tubing having a longitudinal slit there through is provided, where a pair of pull-tabs is arranged on either side of the slit such that the tubing can be pulled open and installed onto the shopping cart handle. In an embodiment, the grip may include clip, pocket, pouch, attachment region, toys, mirror, book, key ring, or calculator. While foam tubing certainly consists of a material thick enough to provide a barrier, it would appear to be neither cost effective to produce, nor easily disposed of, as a substance of this density would likely take many years to break down.

Examination of the prior art has shown a remaining need for a disposable product, which offers an effective barrier between the consumer and germs/bacteria often present on grocery/shopping cart/carry basket/rental stroller handles.

### 6. OBJECTS AND ADVANTAGES

While the above-described examples of prior art may fulfill their respective and particular objectives and requirements, many of the aforementioned patents and patent applications face great disadvantage in that they clearly embody devices GEARED PRIMARILY AT THE ENTERTAINMENT OF INFANTS/CHILDREN. In stark contrast, stands the present invention, A DISPOSABLE SANITARY HANDLE COVER FOR PUBLICLY USED CARTS/RENTAL STROLLERS which intends the protection of the shopping consumer. In view of the foregoing disadvantages as related to handle covers in the existing prior art, the present invention provides an IMPROVMENT in that it's sole objective is to provide the CONSUMER with a barrier to the GERMS/BACTERIA present on grocery/shopping cart/carry basket/rental stroller handles. As such, the present invention overcomes the above mentioned disadvantages and drawbacks of the prior art in that the product is neither designed, nor intended for the use or entertainment of infants/children. *Consequently, the present invention, which will be described subsequently in greater detail, has advantages not previously addressed by the handle cover prior art, and none of the disadvantages related to the aforementioned.

*It is therefore an object of the present invention to provide germ-conscious individuals with an option to solve the problem of dangerous bacteria on public carts/rental strollers in a way not previously afforded to the public. To attain this, the present invention, comprising of a double sided sheet composed of a front/top side made of tissue-type material with an attached back/bottom side made of an isolating plastic material should be installed directly onto the cart handle in use.

*Yet another object of the present invention is to produce a variety of sizes/dimensions of disposable sanitary handle covers for publicly used carts/rental strollers which will accommodate handles of varying measurements.

*It is another object of the present invention to provide a disposable sanitary handle cover for publicly used carts/rental strollers which may be easily and efficiently manufactured and marketed.

*An even further object of the present invention is to provide a disposable sanitary handle cover for publicly used carts/rental strollers with a low cost of manufacture regarding both materials and labor.

*It is another object of the present invention to provide a disposable sanitary handle cover for publicly used carts/rental strollers which has the benefit of a low point of sale price for the purchasing entity, thereby making this product economically accessible.

*Lastly, it is an object of the present invention to provide an effective barrier which can eliminate all need to directly touch cart handles in the future.

These objects of the invention, along with the specific features of novelty that characterize the invention, are pointed out with clarity in the claims section of this disclosure. For a better understanding of the invention, its operating advantages and the specific objects attained by its use, the accompanying drawings and descriptions in which there are illustrated details of the invention should be referenced.

### 7. BRIEF DESCRIPTION OF DRAWINGS

The invention will be better understood and other objects will become apparent when consideration is given to the following brief descriptions. Such descriptions make reference to the annexed drawings in which:

FIG. 1 is a perspective view of the Disposable Sanitary Shopping Cart Handle Cover deployed onto a standard shopping cart, the type particularly common in grocery stores and retail outlets world wide.

FIG. 2-A is a planar view of the invention illustrating the cover as viewed from the front side, after it is removed from a dispenser, and prior to being affixed onto a shopping cart handle.

FIG. 2-B is a planar view of the invention illustrating the cover as viewed from the back side after it is removed from a dispenser and prior to removing the release liner that is taken off when the Disposable Sanitary Shopping Cart Handle Cover is affixed to a shopping cart.

FIG. 3-A is a planar view of the invention illustrating an alternative variation designed to accommodate a shopping cart handle with a drink holder positioned in the center of the handle. The cover is viewed from the front side, after removal from a dispenser, and prior to being affixed onto a shopping cart handle.

FIG. 3-B is a planar view of the invention illustrating an alternative variation designed to accommodate a shopping cart handle with a drink holder positioned in the center of the handle. The cover is viewed from the back side after it is removed from a dispenser and prior to removing the release liners that are taken off when the Disposable Sanitary Shopping Cart Handle Cover is affixed to a shopping cart.

FIG. 4-A is a planar view of the invention illustrating an alternative variation designed to accommodate a carry basket with a metal handle. The cover is viewed from the front side, after it is removed from a dispenser and prior to affixing onto a carry basket handle.

FIG. 4-B is a planar view of the invention illustrating an alternative variation designed to accommodate a carry basket with a metal handle. The cover is viewed from the back side, after removal from a dispenser and prior to removing the release liner that is taken off when the Disposable Sanitary Shopping Handle Cover is affixed onto the basket handle to be used.

FIG. 5-A is a planar view of the invention illustrating an alternative variation designed to accommodate a carry basket with a plastic handle. The cover is viewed from the front side, after it is removed from a dispenser and prior to affixing onto a carry basket handle.

FIG. 5-B is a planar view of the invention illustrating an alternative variation designed to accommodate a carry basket with a plastic handle. The cover is viewed from the back side, after removal from a dispenser and prior to removing the release liner that is taken off when the Disposable Sanitary Shopping Handle Cover is affixed onto the basket handle to be used.

FIG. 6-A is a planar view of the invention illustrating an alternative variation designed to accommodate a child seating/transportation device, such as a publicly used stroller. The cover is viewed from the front side, after it is removed from a dispenser and prior to affixing onto a public stroller handle.

FIG. 6-B is a planar view of the invention illustrating an alternative variation designed to accommodate a child seating/transportation device, such as a publicly used stroller. The cover is viewed from the back side, after it is removed from a dispenser and prior to removing the release liner that is taken off when the Disposable Sanitary Handle Cover is affixed onto the stroller handle to be used.

FIG. 7-A is a planar view of the invention illustrating an alternative variation designed to accommodate a child seating/transportation device, such as a publicly used stroller with a center hook for hanging a bag or other article. The cover is viewed from the front side, after it is removed from a dispenser and prior to affixing onto a public stroller handle.

FIG. 7-B is a planar view of the invention illustrating an alternative variation designed to accommodate a child seating/transportation device, such as a publicly used stroller with a center hook for hanging a bag or other article. The cover is viewed from the back side, after it is removed from a dispenser and prior to removing the release liners that are taken off when the Disposable Sanitary Handle Cover is affixed onto the stroller handle to be used.

FIG. 8 is a front view of the covers as they would appear when manufactured on a roll in a vertical format, that being the construction of the covers from end to end, with the left edge of said cover adjoined to the right edge of the next cover on the roll for use.

FIG. 9 is a front view of the covers as they would appear when manufactured on a roll in a horizontal format, that being the construction of the covers from top to bottom, with the top edge of said cover adjoined to the bottom edge of the next cover on the roll for use.

### 8. DRAWINGS—REFERENCE NUMERALS

The following is a description of the reference numerals used in the drawings.
10 shopping cart handle cover
12 planar view of front tissue-type material
14 planar view of back isolating plastic material
16 adhesive coating
18 pressure sensitive release liner

˜A broad description of the main features of this invention has been outlined in order that the detailed description which will follow may be better under stood and appreciated. Features and advantages of this invention will be readily apparent to those of ordinary skill in the art upon reading the detailed description of the presently preferred invention. In this respect, it should be understood that the invention is not limited in its application to the details of the preferred construction materials, arrangements, measurements, or bonding substance used for attachment, as described in the following description and illustrations of the drawings.

### 9. DETAILED DESCRIPTION OF THE PREFERRED EMBODIMENT

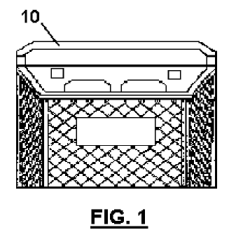

Referring now to the drawings and particularly to FIGS. 1-9, a preferred embodiment and alternate versions of the present invention are shown and specific aspects of the invention are designated by the reference numerals 10 through 18.

FIG. 1 shows the cover 10 for a grocery/shopping cart/carry basket/rental stroller handle deployed onto a standard shopping cart, the type typically found in grocery stores and retail outlets worldwide. By viewing the figure, one can see that the cover 10 provides a sanitary protective covering over the horizontal handle area and affords the consumer a sanitary barrier. The cover achieves this by forming an encasement around the handle as the top edge of the top side 12 of the rectangle is placed upon the top portion of the handle area and wraps around the handle until the bottom edge of the top side 12 of the rectangle reaches the starting point of the top edge of said rectangle. The bottom edge is then adhered to the top edge with a pressure sensitive adhesive coating 16 which is reinforced onto the back side 14 of the rectangle and pressed firmly to the front side 12 to create a seal.

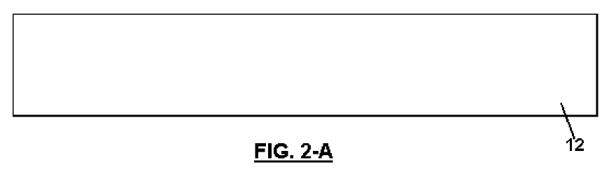

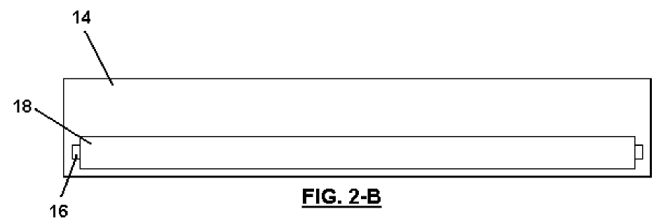

FIG. 2-A depicts a planar view of the first preferred embodiment of the invention showing the front/top side 12 of a Disposable Sanitary Shopping Cart Handle Cover 10 which is constructed in accordance with the principles of the present invention. The handle cover 10 is preferably fabricated from a thin rectangle of materials consisting of a double sided sheet composed of a front/top side 12 made of a tissue-type material with an attached back/bottom side 14, as shown in FIG. 2-B, made of an isolating plastic material wherein the preferred embodiment being one of approximately 30 inches in width, that being a measurement from left to right, and approximately 5 inches in length, that being a measurement from top to bottom, with 2-B described from a back/bottom 14 view. Upon examination of FIG. 2-B, one's attention is drawn to the pressure sensitive adhesive coating 16 and the release liner 18 depicted at the back/bottom 14 of the drawing. The pressure sensitive adhesive coating 16 should be directly coated onto the isolating plastic material of the back/bottom 14 side, and have a release liner 18 that is removed just prior to/during application of the Disposable Sanitary Shopping Cart Handle Cover 10. The adhesive coating 16 is preferably applied as a double-sided tape covered with a release liner 18. The liner 18 should be wider than the adhesive coating 16, creating an edge void that facilitates a lifting edge for the initiation and removal of the release liner 18.

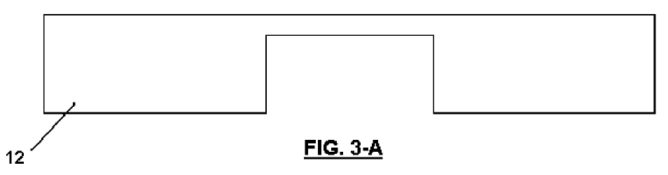

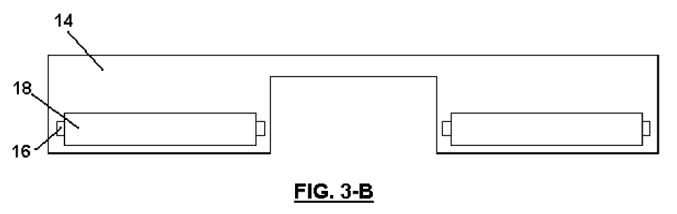

FIG. 3-A shows yet another embodiment of the present invention and does not depart from the essential feature of the present invention with the exception of the measurements. Such departure being one of an alternate measurement, as apparent when viewing the front/top side 12 of the preferred embodiment, made of a tissue-type material, to exhibit a dimension of approximately 33 inches in total width. Furthermore, the front/top side 12 beginning at the left edge of said rectangle exhibits a measurement from left to right of 12 inches with a measurement of 5 inches in length. The preferred embodiment further exhibits a center front/top side 12 section also measuring from left to right beginning at the farthest right edge of the left section of said rectangle and extends 9 inches across the center of the rectangle, with a measurement from top to bottom of 1 inch. The front/top side 12 lastly exhibiting a final section, beginning from the farthest right edge of the center section of said rectangle also measuring from left to right 12 inches, also approximately 5 inches in length, that being a measurement from top to bottom. As with FIG. 1 of the Disposable Sanitary Shopping Cart Handle Cover 10, this alternate embodiment of FIG. 3-A is fully intended to wrap around and completely cover the shopping cart handle in use.

FIG. 3-B, shows the back/bottom side 14, of the alternate embodiment referred to in FIG. 3-A. The back/bottom side 14 is made of an isolating plastic material wherein the cover 10 has a measurement of approximately 33 inches in total width. Furthermore, the back/bottom side 14, beginning at the left edge of said rectangle exhibits a measurement from left to right of 12 inches with a measurement of 5 inches in length. The preferred embodiment further exhibits a center back/bottom side 14 section also measuring from left to right beginning at the farthest right edge of the left section of said rectangle and extends 9 inches across the center of the rectangle, with a measurement from top to bottom of 1 inch. The back/bottom side 14 lastly exhibits a final section, beginning from the farthest right edge of the center section of said rectangle also measuring from left to right 12 inches, also approximately 5 inches in length, that being a measurement from top to bottom. Upon examination of FIG. 3-B, one's attention is drawn to the pressure sensitive adhesive coatings 16 and the release liners 18 depicted at the back/bottom 14 of the drawing. The pressure sensitive adhesive coatings 16 should be directly coated onto the isolating plastic material of the back/bottom 14 side, and have release liners 18 that are to be removed just prior to/during application of the Disposable Sanitary Shopping Cart Handle Cover 10. The adhesive coatings 16 are preferably applied as double-sided tape covered with release liners 18. The liners 18 should be wider than the adhesive coatings 16, creating an edge void that facilitates a lifting edge for the initiation and removal of the release liners 18.

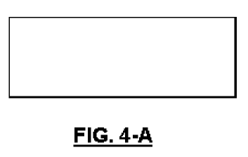

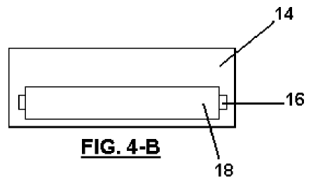

Examination of FIG. 4-A shows an alternate embodiment of the present invention which, like FIG. 3-A, does not depart from the essential feature of the present invention with the exception of the measurements. The alternate dimensions of approximately 12 inches in total width, and 4 inches in length, are apparent when viewing the front/top side 12 of the preferred embodiment. When viewing FIG. 4-B we see the back/bottom side 14, of the alternate embodiment referred to in FIG. 4-A. When viewed, the back/bottom side 14 of FIG. 4-B, made of an isolating plastic material, measuring approximately 12 inches in total width and 4 inches in length, exhibits the pressure sensitive adhesive coating 16, and the release liner 18 depicted at the back/bottom 14 of the drawing. The pressure sensitive adhesive coating 16 should be directly coated onto the isolating plastic material of the back/bottom 14 side, and have a release liner 18 that is removed just prior to/during application of the Disposable Sanitary Shopping Cart Handle Cover 10. The adhesive coating 16 is preferably applied as double-sided tape covered with a release liner 18. The liner 18 should be wider than the adhesive coating 16, creating an edge void that facilitates a lifting edge for the initiation and removal of the release liner 18.

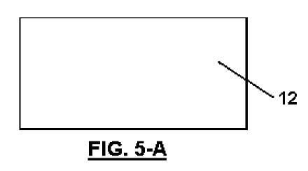

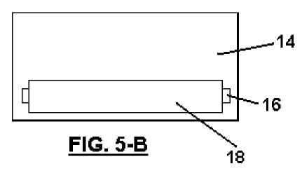

FIG. 5-A shows an alternate embodiment of the present invention which, like FIGS. 3-A and 4-A does not depart from the essential feature of the present invention with the exception of the measurements. The alternate dimensions of approximately 12 inches in total width, and 6 inches in length, are apparent when viewing the front/top side 12 of the preferred embodiment.

FIG. 5-B shows the back/bottom side 14, of the alternate embodiment referred to in FIG. 5-A. When viewed, the back/bottom side 14 of FIG. 5-B, made of an isolating plastic material, measuring approximately 12 inches in total width and 6 inches in length, exhibits the pressure sensitive adhesive coating 16, and the release liner 18 depicted at the back/bottom 14 of the drawing. The pressure sensitive adhesive coating 16 should be directly coated onto the isolating plastic material of the back/bottom 14 side, and have a release liner 18 that is removed just prior to/during application of the Disposable Sanitary Shopping Cart Handle Cover 10. The adhesive coating 16 is preferably applied as double-sided tape covered with a release liner 18. The liner 18 should be wider than the adhesive coating 16, creating an edge void that facilitates a lifting edge for the initiation and removal of the release liner 18.

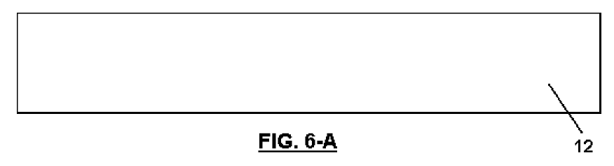

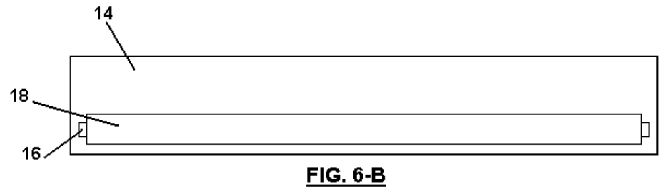

Referring now to FIG. 6-A, we see yet another alternate embodiment of the invention, that being a planar view of the front/top side 12, made of a tissue-type material, illustrating a variation designed to accommodate the handle of a child seating/transportation device, such as a publicly used stroller, which is constructed in accordance with the principles of the present invention. This handle cover 10 exhibits a measurement from left to right, of approximately 30 inches in width, and measuring from top to bottom, approximately 5 inches in length. Examination of FIG. 6-B shows the back/bottom side 14, of the alternate embodiment designed to accommodate the handle of a child seating/transportation device, such as a publicly used stroller, as referred to in FIG. 6-A. When viewed, the back/bottom side 14 of FIG. 6-B, made of an isolating plastic material, measuring approximately 30 inches in total width and 5 inches in length, exhibits the pressure sensitive adhesive coating 16, and the release liner 18 depicted at the back/bottom 14 of the drawing. The pressure sensitive adhesive coating 16 should be directly coated onto the isolating plastic material of the back/bottom 14 side, and have a release liner 18 that is removed just prior to/during application of the Disposable Sanitary Shopping Cart Handle Cover 10. The adhesive coating 16 is preferably applied as double-sided tape covered with a release liner 18. The liner 18 should be wider than the adhesive coating 16, creating an edge void that facilitates a lifting edge for the initiation and removal of the release liner 18.

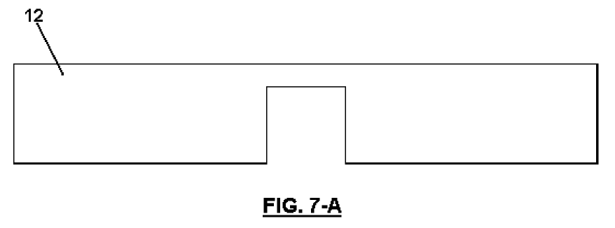

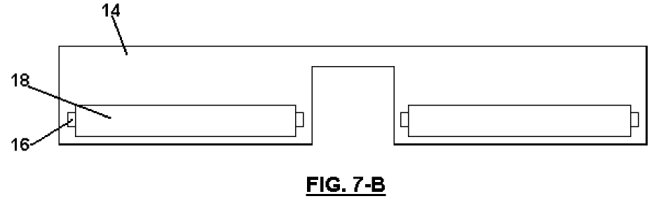

FIG. 7-A, also exhibits an alternate embodiment of the invention, showing a planar view of the front/top side 12, made of a tissue-type material. Illustrating a variation designed to accommodate the handle of a child seating/transportation device, such as a publicly used stroller, with a center hook for hanging a bag or other article, and constructed in accordance with the principles of the present invention. The preferred embodiment beginning at the left edge of said rectangle, exhibits a measurement from left to right of 13 inches with a measurement of 5 inches in length, a center section also measuring from left to right beginning at the farthest right edge of the left section of said rectangle and extends 4 inches across the center of the rectangle, with a measurement from top to bottom of 1 inch, and extending across the top portion only of said handle. Lastly, exhibiting a final section beginning from the farthest right edge of the center section of said rectangle is measured from left to right 13 inches, also approximately 5 inches measured from top to bottom. FIG. 7-B, shows the back/bottom side 14, of the alternate embodiment referred to in FIG. 7-A, which accommodates the handle of a child seating/transportation device, such as a publicly used stroller, with a center hook for hanging a bag or other article. The back/bottom side 14 is made of an isolating plastic material wherein the cover 10 has a measurement of approximately 30 inches in total width. Upon examination of FIG. 7-B, one's attention is drawn to the pressure sensitive adhesive coatings 16 and the release liners 18 depicted at the back/bottom sides 14 of the drawing. The pressure sensitive adhesive coatings 16 should be directly coated onto the isolating plastic material of the back/bottom 14, left and right sides, and have release liners 18 that are to be removed just prior to/during application of the Disposable Sanitary Shopping Cart Handle Cover 10. The adhesive coatings 16 are preferably applied as double-sided tape covered with release liners 18, which should be wider than the adhesive coatings 16, to create an edge void that facilitates a lifting edge for the initiation and removal of the release liners 18.

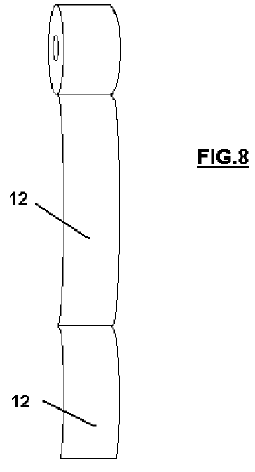

FIG. 8 exhibits a front view of the Disposable Sanitary Shopping Cart Handle Cover 10 as they would appear when manufactured on a roll in a vertical format, that being the construction of the covers 10 with the left edge of said cover 10 adjoined to the right edge of the next cover 10 on the roll for use. The cover 10 has a breakable vertical plurality of perforations which enable one cover 10 to be separated from the next cover 10 on the roll offered for use.

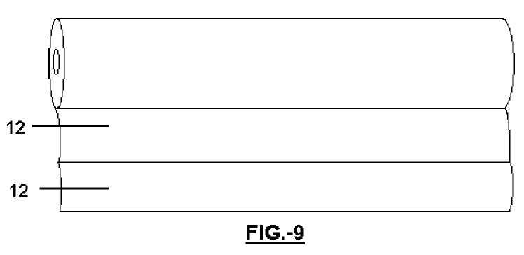

In viewing FIG. 9, we see a front view of the covers 10 as they would appear when manufactured on a roll in a horizontal format, that being the construction of the covers 10 with the top edge of said cover 10 adjoined to the bottom edge of the next cover 10 with a breakable horizontal plurality of perforations which enable one cover 10 to be separated from the next cover 10 on the roll offered for use.

˜Although the preferred embodiment of the invention, a Disposable Sanitary Shopping Cart Handle Cover 10 for publicly used carts/rental strollers has been described in detail, it should be known that modifications and variations thereto, such as slight variations in the width of the rectangle, that being from left side to right side, occasionally also being a variation of the length of the rectangle, that being from top to bottom, are possible. All of which fall within the true spirit and scope of the invention. With respect to the above descriptions, it is to be realized that the optimum dimensional relationships for the cover 10 for publicly used carts/baskets/rental strollers, including variations in size, materials, shape, form, function, manner of operation, assembly and use, are deemed readily apparent and obvious to one skilled in the art, and all equivalent relationships to those illustrated in the drawings and described in the specification are intended to be encompassed by the present invention. For example, any disposable materials having properties such as flexibility, durability, non-toxicity, padded softness, and an isolating quality are suitable for manufacture instead of the presently preferred tissue-type material combined with the presently preferred isolating plastic material as described. Furthermore, a manufactured handle cover 10, evidenced by a measurement from left to right, which measures up to 30 inches wider or 15 inches less wide, than that as claimed in the independent claim 1 and described in the dependent claims of 2-20, is also intended to be encompassed by the present invention. Likewise, a manufactured handle cover, evidenced by a measurement from top to bottom, that would measure up to 10 inches longer or up to 5 inches shorter, than that as claimed in the independent claim 1 and further described in the dependent claims of 2-20 is also intended to be encompassed by the present invention. Therefore, the foregoing is considered as illustrative only of the principles of the invention. Further, since the possibility of modifications and changes will readily occur to those skilled in the art, it is not desired to limit the invention to the exact construction and operation shown and described, and accordingly, all suitable modifications and equivalents may be resorted to, falling within the scope of the invention

### 9. SUMMARY

Ours is a world of consumption, we are ALL consumers. People all need to shop, to eat, to obtain the goods and products necessary to thrive. No matter how rich we are, how famous or average or poor, we all must shop. . . . And, we all must face the continuous exposure to germs and bacteria that spread from person to person through direct contact with grocery/shopping cart/carry basket handles and other publicly used devices.

The worldwide use of carts in grocery stores, discount stores, and a myriad of other retail outlets significantly simplify shopping for the consumer. Allowing customers the ability to pick up desired items for purchase, and put them in the cart, they are afforded the mobility to move through the store freely. However, in spite of all the convenience, every time a shopper touches the handle of a cart, they face direct contact with the germs/bacteria of the previous user. One possible remedy for this situation would be for the store itself to sanitize the handle of each shopping cart after each use. This however, would not be a realistic, cost, or time effective solution for the stores, as numerous customers touch each shopping cart daily.

The present invention addresses health risks consumers are exposed to every time there is a need to touch a cart, carry basket or rental stroller handle. As a disposable product, this invention will be easy to use, relatively inexpensive to produce, and cost effective for stores to offer their customers. This invention has an unequaled advantage in the marketplace, in that, THERE ARE CURRENTLY NO DISPOSABLE BARRIERS AVAILABLE TO THE PUBLIC FOR USE ON GROCERY/SHOPPING CARTS/CARRY BASKET/RENTAL STROLLER HANDLES. There is however, a growing awareness of the high risk of exposure to germs and bacteria, as several grocery stores through out the U.S. have begun to offer disposable wipes near the shopping carts for consumers to wipe the handles of the shopping carts clean.

What is claimed is:

1. A disposable sanitary shopping cart handle cover for publicly used grocery/shopping cart/carry basket/rental strollers comprising: a relatively thin rectangle of disposable material consisting of a double sided sheet composed of a front/top side made of a tissue-type material with an attached back/bottom side made of an isolating plastic material whereby said cover provides a barrier to the health risk of germs/bacteria by eliminating direct contact with unsanitary conditions on said handles.

2. The disposable sanitary shopping cart handle cover as defined in claim 1, wherein the preferred embodiment is one of approximately 30 inches in width, that being a measurement from left to right, and approximately 5 inches in length, that being a measurement from top to bottom, which wraps around the shopping cart handle intended for use, completely covering both the metal and plastic portions of the said handle.

3. The disposable sanitary shopping cart handle cover as described in claim 1, wherein the cover forms an encasement around the handle intended for use as the top edge of the rectangle is placed upon the top portion of the cart handle and wrapped around the handle until the bottom edge of the rectangle has reached the starting point of the top edge of the rectangle, said bottom edge then being adhered to the top edge with a pressure sensitive adhesive coating which is reinforced onto the back/bottom side of the rectangle and pressed firmly to the top side to create a seal.

4. The disposable sanitary shopping cart handle cover as described in claim 3, wherein the pressure sensitive adhesive coating is protected with a removable release liner, with design of said liner possibly wider, possibly the same width as the coated adhesive, thereby forming a lifting edge for initiating removal of the liner.

5. The disposable sanitary shopping cart handle cover as described in claim 1, wherein the preferred embodiment is one of approximately 33 inches in total width, beginning at the left edge of said rectangle, exhibiting a measurement from left to right of approximately 12 inches with a measurement of approximately 5 inches in length, a center section also measuring from left to right beginning at the farthest right edge of the left section of said rectangle and extending approximately 9 inches across the center of the rectangle, with a measurement from top to bottom of approximately 1 inch, and lastly exhibiting a final section beginning from the farthest right edge of the center section of said rectangle also measuring from left to right approximately 12 inches, also approximately 5 inches in length, that being a measurement from top to bottom.

6. The disposable sanitary shopping cart handle cover as described in claim 5, wherein the cover forms an encasement as the top edge of the rectangle is placed upon the top portion of the cart handle and wrapped around until both left and right bottom edges of the rectangle have reached the starting point of the top edge of the rectangle, said bottom edges then being adhered to the top edge with a pressure sensitive adhesive coating reinforced onto the back/bottom left and back/bottom right sides of the rectangle and pressed firmly to the top side creating a seal.

7. The disposable sanitary shopping cart handle cover as described in claim 5, wherein the pressure sensitive adhesive coating on the back/bottom of both the left and right sides of said cover are protected with a removable release liner, with said release liners possibly being slightly wider, possibly the same width as the coated adhesive, thereby forming a lifting edge for initiating removal of the liners.

8. The disposable sanitary shopping cart handle cover as described in claim 1, wherein the preferred embodiment is one of approximately 12 inches in width and approximately 4 inches in length, said cover designed to wrap around the metal handles of a shopping carry basket intended for use.

9. The disposable sanitary shopping cart handle cover as described in claim 8, wherein said cover forms an encasement upon grasping each handle of the basket separately, bringing them together until the two handles are touching, placing the top edge of the rectangle upon the top portion of the basket handles, then wrapping around the handles until the bottom edge of the rectangle has reached the starting point of the top edge of the rectangle, said bottom edge then adhering to the top edge with the pressure sensitive adhesive coating reinforced onto the back/bottom side of the rectangle and pressed firmly to the top side of the rectangle to create a seal.

10. The disposable sanitary shopping cart handle cover as described in claim 8, wherein the pressure sensitive adhesive coating is protected with a removable release liner, with said release liner possibly slightly wider, possibly the same width as the coated adhesive, thereby forming a lifting edge for initiating removal of the liner.

11. The disposable sanitary shopping cart handle cover as described in claim 1, wherein the preferred embodiment is one of approximately 12 inches in width and approximately 6 inches in length, with said cover designed to wrap around the plastic handles of a shopping carry basket intended for use.

12. The disposable sanitary shopping cart handle cover as described in claim 11, wherein the cover forms an encasement upon grasping each handle of the basket separately, bringing them together until the two handles are touching, placing the top edge of the rectangle upon the top portion of the basket handles, then wrapping around the handles until the bottom edge of the rectangle has reached the starting point of the top edge of the rectangle, said bottom edge then adhering to the top edge with the pressure sensitive adhesive coating reinforced onto the back/bottom side of the rectangle and pressed firmly to the top side of the rectangle to create a seal.

13. The disposable sanitary shopping cart handle cover as described in claim 11, wherein the pressure sensitive adhesive coating is protected with a removable release liner, said release liner possibly wider, possibly the same width as the coated adhesive, thereby forming a lifting edge for initiating removal of the liner.

14. The disposable sanitary cart handle cover as described in claim 1, wherein the preferred embodiment is designed to wrap around the handle area of a child seating/transportation device, such as a publicly used stroller whereby the cover forms an encasement wrapping around the handle until the bottom edge of the rectangle has reached the starting point of the top edge of the rectangle, said bottom edge then adhering to the top edge with the pressure sensitive adhesive coating reinforced onto the back/bottom side of the rectangle and pressed firmly to the top side of the rectangle to create a seal.

15. The disposable sanitary cart handle cover as described in claim 14, wherein the pressure sensitive adhesive coating is protected with a removable release liner with said release liner possibly wider than, possibly the same width as the coated adhesive, thereby forming a lifting edge for initiating removal of the liner.

16. The disposable sanitary cart handle cover as claimed in claim 1, whereby said cover is designed for use on public stroller handles, wherein the preferred embodiment beginning at the left edge of said rectangle, exhibits a measurement from left to right of approximately 13 inches with a measurement of approximately 5 inches in length, further exhibiting a center section also measuring from left to right beginning at the farthest right edge of the left section of said rectangle and extending approximately 4 inches across the center of the rectangle, with a measurement from top to bottom of approximately 1 inch with cover lastly exhibiting a final section beginning from the farthest right edge of the center section of said rectangle, measuring from left to right approximately 13 inches, also measured from top to bottom approximately 5 inches.

17. The disposable sanitary cart handle cover as described in claim 16, wherein the cover forms an encasement as the top edge of the rectangle is placed upon the top portion of the cart handle, wrapped around the handle until both left bottom edge of the rectangle and right bottom edge of the rectangle have reached the starting point of the top edge of the rectangle, with said bottom edges then adhering to the top edge with a pressure sensitive adhesive coating which is reinforced onto the back left and right sides of the rectangle and pressed firmly to the front side to create a seal.

18. The disposable sanitary cart handle cover as described in claim 16, wherein the pressure sensitive adhesive coating is protected with a removable release liner with said release liner possibly slightly wider, possibly the same width as the coated adhesive for initiating removal of the release liner thereby forming a lifting edge.

19. The disposable sanitary shopping cart handle cover as described in the independent claim 1, and further clarified in dependent claims 2-18 wherein said cover is manufactured on a roll with the preferred embodied arrangement being one with the left edge of said cover adjoined to the right edge of the previous cover which when installed and displayed within a dispenser reveals a vertical breakable plurality of perforations between each cover, said perforations then initiate detachment of one cover from the next cover when torn.

20. The disposable sanitary shopping cart handle cover as described in the independent claim 1, and further clarified in the dependent claims 2-18, wherein said cover is manufactured as sheets on a roll with the preferred embodiment being an arrangement of top to bottom which reveal a breakable horizontal plurality of perforations, initiating detachment of the cover at the point of the top portion of said cover from the point of the bottom portion of the next cover when torn.
